(19) United States
(12) Patent Application Publication
(10) Pub. No.: US 2008/0018969 A1
(43) Pub. Date: Jan. 24, 2008

(54) Optical Integrated Unit Including Hologram Element and Optical Pickup Device

(75) Inventors: Keiji Sakai, Nara-shi (JP); Renzaburoh Miki, Soraku-gun (JP); Yukio Watanabe, Uji-shi (JP); Osamu Miyazaki, Soraku-gun (JP)

Correspondence Address: EDWARDS ANGELL PALMER & DODGE LLP, P.O. BOX 55874, BOSTON, MA, 02205, US

(73) Assignee: SHARP KABUSHIKI KAISHA, OSAKA (JP)

(21) Appl. No.: 10/586,021

(22) PCT Filed: Jan. 11, 2005
(86) PCT No.: PCT/JP05/00182

§ 371 Date: Apr. 13, 2007

(30) Foreign Application Priority Data
Jan. 16, 2004 (JP) 2004-009227

(51) Int. Cl. G02B 5/32

(52) U.S. Cl. 359/15

(57) ABSTRACT

An optical integrated unit includes a light-emitting portion for emitting a plurality of laser beams having different wavelengths, a wave plate, a polarization hologram element for diffracting a first laser beam emitted from a light source, and a non-polarization hologram element for diffracting a second laser beam emitted from a light source. Wave plate is formed to act as a λ/4 plate for the first laser beam and act as a λ plate or a λ/2 plate for the second laser beam.

### TECHNICAL FIELD

The present invention relates to an optical integrated unit and an optical pickup device optically recording or reproducing information onto/from an information recording medium such as an optical disk.

### BACKGROUND ART

Some optical integrated units optically recording or reproducing information onto/from an optical disk as an information recording medium correspond to two kinds of optical disks. For example, some optical integrated units have a light source emitting laser light having a wavelength of 655 nm for recording or reproduction onto/from a DVD (Digital Versatile Disc)-type optical disk and a light source emitting laser light having a wavelength of 785 nm for recording or reproduction onto/from a CD (Compact Disk)-type optical disk.

An optical integrated unit includes these two kinds of light sources arranged at positions apart from each other and uses an optical element for combining/separating two laser beams so that the optical integrated unit is adapted to two laser beams (see, for example, Japanese Patent Laying-Open No. 2000-76689).

Japanese Patent Laying-Open No. 2000-76689 discloses an optical pickup device including a plurality of semiconductor lasers at wavelengths different from each other arranged in proximity to each other and an optical pickup device including a plurality of semiconductor lasers arranged in one package. FIG. 11 shows a cross sectional view of an optical pickup device including two semiconductor lasers arranged in proximity to each other. Semiconductor lasers 101, 102 and a light-receiving element 114 are arranged in a laser package 115. Laser beams emitted from semiconductor lasers 101, 102 pass through a three-beam diffraction grating 103, a second hologram element 111, a first hologram element 112, a collimator lens 113, and an objective lens 106 to irradiate disk 107.

Reflected light from disk 107 passes through objective lens 106 and collimator lens 113 to enter first hologram element 112. First hologram element 112 is formed on the upper surface of a transparent substrate 117 and is formed to diffract laser light having a wavelength of 650 nm band and not to diffract laser light having a wavelength of 780 nm band. Laser light having a wavelength of 650 nm band is diffracted at first hologram element 112.

Laser light passing through first hologram element 112 enters second hologram element 111. Second hologram element 111 is formed on the upper surface of a transparent substrate 116 and is formed to diffract laser light having a wavelength of 780 nm band and not to diffract laser light having a wavelength of 650 nm band by adjusting the depth of groove of the hologram. Laser light having a wavelength of 780 nm band is diffracted at second hologram element 111.

Laser light having a wavelength of 650 nm band diffracted at first hologram element 112 and laser light having a wavelength of 780 nm band diffracted at second hologram element 111 enter light-receiving element 114.

In the device shown in FIG. 11, first hologram element 112 and second hologram element 111 are arranged on the same optical axis of oscillation, and diffraction light beams at the two hologram elements are received by one light-receiving element 114, thereby achieving a miniaturized integrated optical pickup device.

FIG. 12 shows a cross sectional view of an optical pickup device disclosed in Japanese Patent Laying-Open No. 2003-109243 as another optical pickup device. Laser beams emitted from semiconductor laser chips 121, 123 pass through a first hologram 124, a second hologram 125, a wave plate 130, a collimator lens 126, and an objective lens 127 to enter an optical recording medium 128.

Reflected light from optical recording medium 128 passes through objective lens 127, collimator lens 126 and wave plate 130 to enter second hologram 125. Wave plate 130 is formed such that a phase difference applied to laser light with a wavelength of 660 nm is 109° and a phase difference applied to laser light with a wavelength of 780 nm is 71°.

Second hologram 125 is a non-polarization hologram having diffraction efficiency approximately constant irrespective of a polarization direction of incident light. Second hologram 125 has such wavelength selectivity in that laser light having a wavelength of 660 nm is not diffracted and laser light having a wavelength of 780 nm is diffracted. Therefore, laser light having a wavelength of 780 nm is diffracted at second hologram 125. Laser light passing through second hologram 125 enters first hologram 124. First hologram 124 is a polarization hologram for diffracting laser light having a wavelength of 660 nm. Laser light having a wavelength of 660 nm is diffracted at first hologram 124.

Laser light having a wavelength of 660 nm diffracted at first hologram 124 and laser light having a wavelength of 780 nm diffracted at second hologram 125 are introduced to a light-receiving element 129 for detection.

A wave plate providing a phase difference close to 90° to some extent to two laser beams is used as wave plate 130. A deviation of the provided phase difference from 90° is permitted as a reduction in the detected signal. It is also technically possible to form a wave plate applying a phase difference of 90° to each of two laser beams. However, a wave plate having such a characteristic is not advantageous in view of costs, and therefore the phase difference to be provided is formed to have an angle shifted from 90°. Returning light from optical recording medium 128, which passes through the wave plate to attain a phase difference shifted from 90°, is elliptical polarization for both of the two light beams.

Patent Document 1: Japanese Patent Laying-Open No. 2000-76689

Patent Document 2: Japanese Patent Laying-Open No. 2003-109243

### DISCLOSURE OF THE INVENTION

### Problems to be Solved by the Invention

The optical pickup device having two light sources arranged apart from each other requires an optical element for combining and separating two laser beams, thereby increasing the number of components. In addition, an optical system needs to be adjusted to be adapted to two light sources arranged apart from each other, thereby increasing the adjusted parts. For example, an optical element is adjusted in position after arrangement of one light source and in addition, the other light source has to be adjusted in position. Moreover, many optical elements are required to combine and separate two laser beams emitted from two light sources arranged apart from each other, thereby increasing the size of the optical pickup device.

In the optical pickup device shown in FIG. 11, hologram elements each having the wavelength selectivity with the adjusted depth of the groove of the hologram are arranged on the same optical axis. Used are first hologram element 112 for diffracting laser light having a wavelength of 650 nm and second hologram element 111 for diffracting laser light having a wavelength of 780 nm.

However, in each of these hologram elements, the laser beam is diffracted irrespective of the direction in which the laser beam enters. In other words, each laser beam is diffracted for not only reflected light from disk 107 but also oscillation light from semiconductor lasers 101, 102 to disk 107.

Therefore, two laser beams emitted from semiconductor lasers 101, 102 to disk 107 are diffracted once at second hologram element 111 or first hologram element 112, and then transmitted light through each hologram element (zero-order diffraction light) enters disk 107. The laser light reflected on disk 107 enters first hologram element 112 or second hologram element 111 again and is then diffracted, so that +1 order diffraction light or −1 order diffraction light is received by light-receiving element 114. In this manner, two laser beams are both diffracted once on each of the outgoing path and the incoming path, so that, for both of the laser beams, the output efficiency from the objective lens is bad in the outgoing path and the light-receiving efficiency at the light-receiving element is worse in the incoming path.

Laser light having a wavelength of 650 nm, in particular, is used for reproduction and recording from/onto DVD having a recording density higher than CD, so that the light-receiving efficiency has to be increased to increase S/N ratio of a reproduction signal. However, in the optical pickup device shown in FIG. 11, when information is recorded onto an optical disk, insufficient quantity of light is caused to hinder high-speed reproduction or high-speed recording.

In the optical pickup device shown in FIG. 12, first hologram 124 is used as a polarization hologram. In this device, diffraction light of second hologram 125 preferably has a polarization direction such that it is not diffracted at first hologram 124. However, when reflected light from optical recording medium 128 is circularly polarized light or elliptical polarization formed of two-direction linear polarization, part of diffraction light of second hologram 125 diffracts at first hologram 124 again. In other words, the light utilization efficiency is reduced.

Therefore, as described above, in use of a wave plate providing a phase difference close to 90° to some extent to both of two laser beams, when diffraction light at second hologram 125 passes through first hologram 124, it is diffracted at first hologram 124, so that it is assumed that the quantity of light reaching light-receiving element 129 is significantly reduced.

On the other hand, if the configuration is such that part of laser light diffracted at second hologram 125 passes through that region of first hologram 124 in which hologram is not formed, laser light passing through that region of first hologram 124 in which hologram is formed is partially diffracted and is reduced in quantity of light while laser light passing through that region in which hologram is not formed is not reduced in quantity of light. Therefore, the intensity distribution in the cross section of reflected light from optical recording medium 128 becomes uneven. Since an optical pickup device uses the intensity distribution of reflected light from an optical recording medium to obtain a track error signal, a focus error signal, and the like, uneven intensity distribution of reflected light from an optical recording medium prevents these signals from being obtained accurately.

In addition, if the configuration is such that all of diffraction light of second hologram 125 passes through the region in which first hologram 124 is not formed, the quantity of diffraction light of second hologram 125 is not reduced as described above. In order to achieve this effect, such a configuration is widely used in that second hologram 125 is located away from semiconductor laser chips 121, 123 to increase the distance between first hologram 124 and second hologram 125. However, in such a case, the size of the optical integrated unit is increased in the direction of the optical axis of laser light, which makes it difficult to miniaturize the optical pickup device.

In order to solve the aforementioned problems, an object of the present invention is to provide an optical integrated unit and an optical pickup device having high utilization efficiency of laser light and allowing for miniaturization.

### Means for Solving the Problems

An optical integrated unit in accordance with the present invention includes: a light-emitting portion for emitting a plurality of laser beams having different wavelengths; a phase difference plate; a first hologram element for diffracting a first laser beam of the plurality of laser beams; and a second hologram element for diffracting a second laser beam of said plurality of laser beams. The phase difference plate is formed to act as a λ/4 plate for the first laser beam and to act as a λ plate or a λ/2 plate for the second laser beam. By employing this configuration, when an appropriate hologram element is determined for the first hologram element and the second hologram element, even if diffraction light of one hologram element is passed through the other hologram element, the diffraction light can be prevented from being diffracted at the other hologram element. As a result, such an optical integrated unit can be provided in that the utilization efficiency of laser light is increased and in addition, miniaturization can be achieved.

In the invention as described above, preferably, the light-emitting portion is formed such that a wavelength of the first laser beam is longer than a wavelength of the second laser beam, the first hologram element has a polarization characteristic, and the second hologram element is formed not to depend on a polarization state. By employing this configuration, the first hologram element and the second hologram element can easily be formed.

In the invention described above, preferably, the light-emitting portion is formed such that a wavelength of the first laser beam is longer than a wavelength of the second laser beam, the first hologram element has a polarization characteristic, and the second hologram element is formed not to diffract the first laser beam and to diffract the second laser beam. By employing this configuration, the first hologram element and the second hologram element can easily be formed.

In the invention described above, preferably, oscillation light division means is included for dividing oscillation light from the light-emitting portion into at least three. By employing this configuration, the present invention can be applied to a tracking system using three beams.

In the invention described above, preferably, the oscillation light division means includes a first oscillation light diffraction grating for dividing the first laser beam and a second oscillation light diffraction grating for dividing the second laser beam. By employing this configuration, division can be made corresponding to each laser beam.

In the invention described above, preferably, the oscillation light division means includes a diffraction grating formed to divide the first laser beam and the second laser beam. By employing this configuration, the configuration of the oscillation light division means can be made simple.

In the invention described above, preferably, one light-receiving portion is included for receiving the plurality of laser beams. The first laser beam and the second laser beam are received at the one light-receiving portion. By employing this configuration, the light-receiving portion can be miniaturized, resulting in a miniaturized optical integrated unit.

In the invention described above, preferably, a light-receiving portion is included for receiving the plurality of laser beams. The light-emitting portion, the light-receiving portion, the first hologram element, and the second hologram element are integrated. By employing this configuration, the positions of the first hologram element, the second hologram element, and the like can be adjusted in manufacturing the optical integrated unit, thereby eliminating the necessity for the position adjustment of the above-noted parts when the optical integrated unit is installed in an optical pickup device.

In the invention described above, preferably, a light-receiving portion is included for receiving the plurality of laser beams. The light-emitting portion, the light-receiving portion, the first hologram element, and the second hologram element, and the phase difference plate are integrated. By employing this configuration, the phase difference plate can be arranged close to the light-emitting portion, so that excellent laser beam can be applied to an optical disk. In addition, the position adjustment of the light-emitting portion, the first hologram element, and the like in the optical integrated unit is no longer required when the optical integrated unit is installed in an optical pickup device.

In the invention described above, preferably, a light-receiving portion is included for receiving the plurality of laser beams. The light-emitting portion, the light-receiving portion, the first hologram element, the second hologram element, and the oscillation light division means are integrated. By employing this configuration, the position adjustment of the light-emitting portion, the first hologram element, the oscillation light division means, and the like in the optical integrated unit is no longer required when the optical integrated unit is installed in an optical pickup device.

In the invention described above, preferably, a light-receiving portion is included for receiving the plurality of laser beams. The light-emitting portion, the light-receiving portion, the first hologram element, the second hologram element, the phase difference plate, and the oscillation light division means are integrated. By employing this configuration, the position adjustment between the light-emitting portion and the first hologram element and the like can be made in manufacturing the optical integrated unit, thereby eliminating the necessity for the position adjustment of the above-noted parts when the optical integrated unit is installed in an optical pickup device.

In the invention described above, preferably, the light-emitting portion is integrally formed to be separable from other portions. By employing this configuration, the light-emitting portion can be changed easily.

An optical pickup device in accordance with the present invention includes: the optical integrated unit as described above; and an objective lens for collecting emitted laser beam on an information surface of an optical disk. By employing this configuration, such an optical pickup device can be provided that has high utilization efficiency of laser beams and allows for miniaturization.

In the invention described above, preferably included are: oscillation light division means for dividing oscillation light from the light-emitting portion into at least three; and a light-receiving portion for receiving the plurality of laser beams. The light-emitting portion is formed such that a wavelength of the first laser beam is longer than a wavelength of the second laser beam. The first hologram element has a polarization characteristic. The second hologram element is formed not to depend on a polarization state. The light-emitting portion, the light-receiving portion, the first hologram element, the second hologram element, the phase difference plate, and the oscillation light division means are integrated. By employing this configuration, the position adjustment of the above-noted parts, such as the position adjustment between the light-emitting portion and the first hologram element, is no longer required when the optical integrated unit is installed in an optical pickup device.

### EFFECTS OF THE INVENTION

In accordance with the present invention, it is possible to provide an optical integrated unit and an optical pickup device having high utilization efficiency of laser light and allowing for miniaturization.

### BRIEF DESCRIPTION OF THE DRAWINGS

FIG. 1 is a schematic cross sectional view of a first optical integrated unit and a first optical pickup device in accordance with a first embodiment.

FIG. 2 is a schematic cross sectional view of a second optical integrated unit and a second optical pickup device in accordance with the first embodiment.

FIG. 3 is a schematic cross sectional view of a third optical integrated unit and a third optical pickup device in accordance with the first embodiment.

FIG. 4 is a schematic cross sectional view of a first optical integrated unit and a first optical pickup device in accordance with a second embodiment.

FIG. 5 is a schematic cross sectional view of a second optical integrated unit and a second optical pickup device in accordance with the second embodiment.

FIG. 6 is a schematic cross sectional view of a first optical integrated unit and a first optical pickup device in accordance with a third embodiment.

FIG. 7 is a schematic cross sectional view of a second optical integrated unit and a second optical pickup device in accordance with the third embodiment.

FIG. 8 is a schematic cross sectional view of a third optical integrated unit and a third optical pickup device in accordance with the third embodiment.

FIG. 9 is a schematic cross sectional view of a fourth optical integrated unit and a fourth optical pickup device in accordance with the third embodiment.

FIG. 10 is a schematic cross sectional view of a fifth optical integrated unit and a fifth optical pickup device in accordance with the third embodiment.

FIG. 11 is a cross sectional view of an optical integrated unit and an optical pickup device based on a conventional technique.

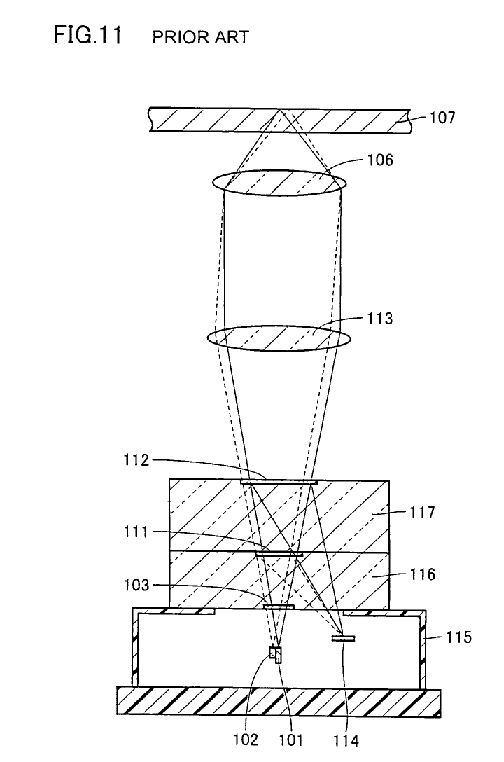

FIG. 12 is a schematic cross sectional view of another optical integrated unit and another optical pickup device based on a conventional technique.

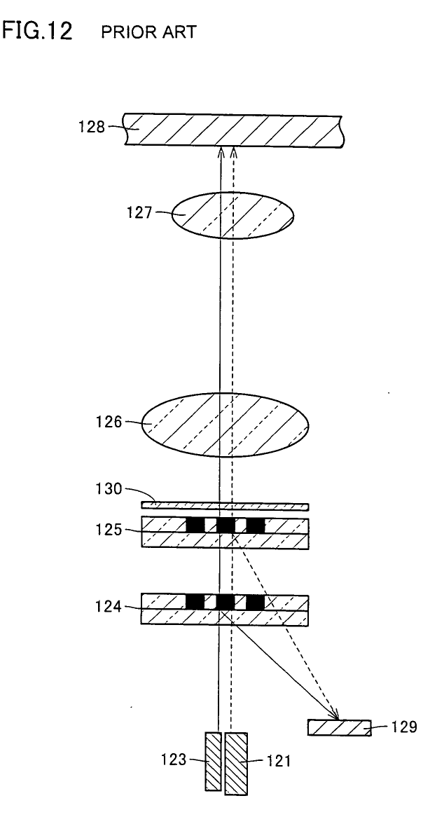

### DESCRIPTION OF THE REFERENCE SIGNS

1, 21 light-emitting portion, 1a, 1b light source, 2, 12, 14, 16 polarization hologram element, 3, 13, 15, 17 non-polarization hologram element, 4a, 4b, 4c light-receiving portion, 5 wave plate, 6 objective lens, 7 optical disk, 8a, 8b, 8c diffraction grating, 9, 10, 11 holder, 22-31 substrate, 35a, 35b diffraction light, 39 base, 40, 42, 44 optical integrated unit, 41, 43, 45 optical pickup device, 101, 102 semiconductor laser, 103 three-beam diffraction grating, 106 objective lens, 107 disk, 111 second hologram element, 112 first hologram element, 113 collimator lens, 114 light-receiving element, 115 laser package, 116, 117 transparent substrate, 121, 123 semiconductor laser chip, 124 first hologram (polarization hologram), 125 second hologram (no-polarization hologram), 126 collimator lens, 127 objective lens, 128 optical recording medium, 129 light-receiving element 130 wave plate, J optical axis.

### BEST MODES FOR CARRYING OUT THE INVENTION

### First Embodiment

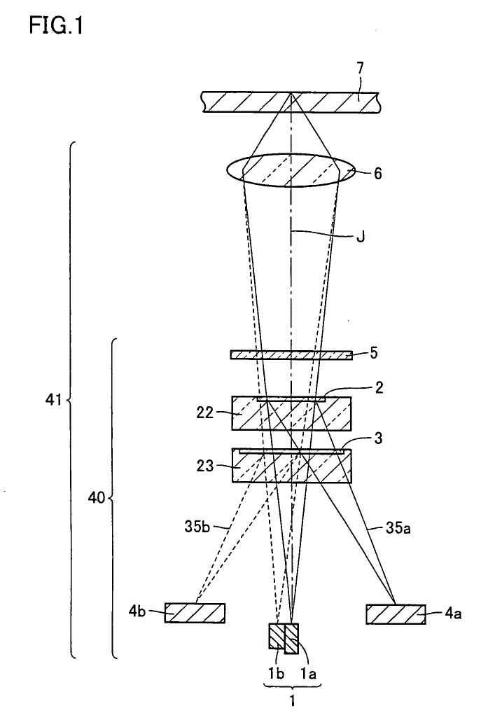

Referring to FIG. 1 to FIG. 3, an optical integrated unit and an optical pickup device in accordance with a first embodiment of the present invention will be described. It is noted that the terms representing the upper surface, above, and the like used in the description of the present invention do not indicate the absolute direction but indicate the relative positional relation of each part.

FIG. 1 is a schematic cross sectional view of a first optical integrated unit and a first optical pickup device in this embodiment. An optical integrated unit 40 includes a light-emitting portion 1 for emitting two laser beams. Light-emitting portion 1 includes a light source 1a and a light source 1b. Light sources 1a and 1b are formed to emit laser light upward in FIG. 1. Light source 1a and light source 1b are formed to emit laser beams having the respective optical axes approximately in the same direction. Light-emitting portion 1 is formed such that a wavelength of a first laser beam emitted from light source 1a is shorter than a wavelength of a second laser beam emitted from light source 1b. For example, laser light having a wavelength of 655 nm is emitted from light source 1a for recording and reproduction onto/from DVD-type optical disk, and laser light having a wavelength of 785 nm is emitted from light source 1b for recording and reproduction onto/from CD-type optical disk.

A substrate 22, a substrate 23, and a wave plate 5 as a phase difference plate are arranged on optical axis J of the first laser beam emitted from light source 1a. A polarization hologram element 2 is formed on the upper surface of substrate 22 as a first hologram element for diffracting the first laser beam emitted from light source 1a. A non-polarization hologram element 3 is formed on the upper surface of substrate 23 as a second hologram element for diffracting the second laser beam emitted from light source 1b. Non-polarization hologram element 3 does not have the polarization characteristic and is formed such that diffraction of laser light does not depend on a polarization state.

Polarization hologram element 2 is formed to diffract laser light in a linear polarization state with 90° rotation with respect to a polarization state of the laser light emitted from light source 1a. Polarization hologram element 2 is arranged such that optical axis J of the first laser beam emitted from light source 1a passes through approximately the middle portion of polarization hologram element 2. Non-polarization hologram element 3 is arranged such that the optical axis of the second laser beam emitted from light source 1b passes through approximately the middle portion of non-polarization hologram element 3. Furthermore, polarization hologram element 2 and non-polarization hologram element 3 are formed on the way of the incoming path through which the two emitted laser beams reflected at optical disk 7 return.

Non-polarization hologram element 3 is formed not to diffract the first laser beam and to diffract the second laser beam. In other words, non-polarization hologram element 3 is formed to have wavelength selectivity. Furthermore, non-polarization hologram element 3 in this embodiment is formed such that, of the diffraction light, the diffraction efficiency of zero-order diffraction light is about 80% and the diffraction efficiency of ±1 order diffraction light is 8%.

Wave plate 5 is formed to act as a λ/4 plate for the first laser beam and act as a λ plate or λ/2 plate for the second laser beam. A light-receiving portion 4a is formed on the side of light-emitting portion 1 to receive diffraction light from polarization hologram element 2. On the other hand, a light-receiving portion 4b is arranged on the side of light-emitting portion 1, which is opposite to the side at which light-receiving portion 4a is arranged, to receive diffraction light from non-polarization hologram element 3. In the present embodiment, of the diffraction light of the polarization hologram element and the non-polarization hologram element, the first-order diffraction light is used.

Optical integrated unit 40 includes light-emitting portion 1, light-receiving portions 4a, 4b, substrates 22, 23, and wave plate 5. Optical pickup device 41 includes an objective lens 6 on optical axis J above wave plate 5 for collecting the emitted laser light at optical disk 7, in addition to optical integrated unit 40.

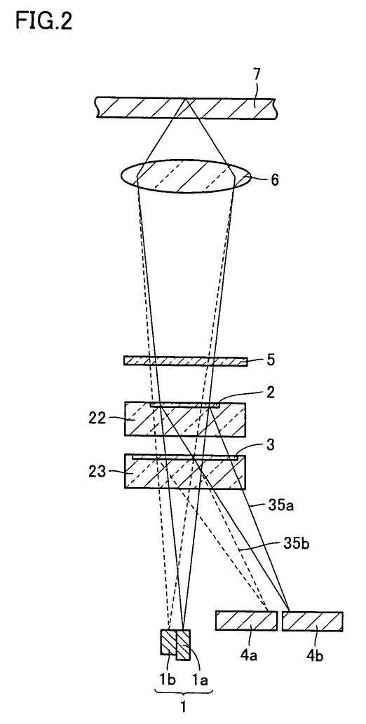

FIG. 2 shows a schematic cross sectional view of a second optical integrated unit and a second optical pickup deice in this embodiment. Similarly to the first optical integrated unit and the first optical pickup device in this embodiment, the optical integrated unit includes light-emitting portion 1, substrates 22, 23, and wave plate 5.

The second optical integrated unit and the second optical pickup device are different in the position of the light-receiving portion. Light-receiving portion 4a and light-receiving portion 4b are arranged both on the same side of light-emitting portion 1. Light-receiving portion 4a and light-receiving portion 4b are arranged such that their respective main surfaces are in the same plane. The optical pickup device is formed such that diffraction light of polarization hologram element 2 is received at light-receiving portion 4b and diffraction light of non-polarization hologram element 3 is received at light-receiving portion 4a. The other configuration is similar to that of the first optical integrated unit and the first optical pickup device in this embodiment.

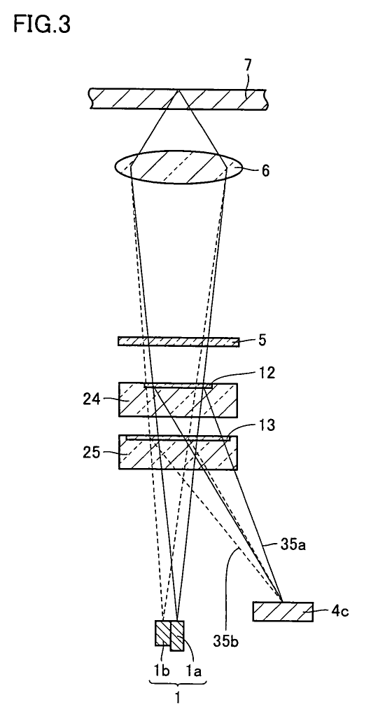

FIG. 3 shows a schematic cross sectional view of a third optical integrated unit and a third optical pickup device in this embodiment. Similarly to the first optical integrated unit and the first optical pickup device in this embodiment, light-emitting portion 1 and wave plate 5 are included, a polarization hologram element 12 is formed on the upper surface of a substrate 24, and a non-polarization hologram element 13 is formed on the upper surface of a substrate 25.

The third optical integrated unit and the third optical pickup device are formed such that two laser beams emitted from the light-emitting portion are received at one light-receiving portion. Polarization hologram element 12 formed on the upper surface of substrate 24 and non-polarization hologram element 13 formed on the upper surface of substrate 25 are formed such that diffraction light 35a of polarization hologram element 12 and diffraction light 35b of non-polarization hologram element 13 reach approximately the same position on the side of light-emitting portion 1. Diffraction light 35a and diffraction light 35b are received at one light-receiving portion 4c. In this way, the third optical integrated unit and the third optical pickup device are formed such that both of the laser beams are received at one light-receiving portion 4c.

The other configuration is similar to that of the first optical integrated unit and the first optical pickup device in this embodiment.

In the present embodiment, light-emitting portion 1 has light source 1a emitting laser light having a short wavelength and light source 1b emitting laser light having a long wavelength. The first laser beam emitted from light source 1a passes through non-polarization hologram element 3 formed on substrate 23 and polarization hologram element 2 formed on substrate 22, is collected at objective lens 6, and enters optical disk 7.

Laser light reflected on optical disk 7 passes through objective lens 6 and wave plate 5 again and is diffracted at polarization hologram element 2 formed on substrate 22. Diffraction light 35a of polarization hologram element 2 passes through the region in which non-polarization hologram element 3 formed on the upper surface of substrate 23 is formed, and reaches light-receiving portion 4a. Light-receiving portion 4a receives diffraction light 35a from which an optical signal is detected.

Wave plate 5 is formed to act as a λ/4 plate for the first laser beam emitted from light source 1a. The first laser beam emitted from light source 1a passes through wave plate 5 to attain the circularly polarized light state and then enters optical disk 7. Reflected light from optical disk 7 passes through wave plate 5 again to attain the linear polarization state with 90° rotation with respect to the polarization direction of the laser light emitted from light source 1a and then enters polarization hologram element 2.

Polarization hologram element 2 is formed to diffract this reflected light in linear polarization state with 90° rotation. Therefore, reflected light of the first laser beam emitted from light source 1a is diffracted at polarization hologram element 2 and is introduced to light-receiving portion 4a.

The second laser beam emitted from light source 1b passes through non-polarization hologram element 3, polarization hologram element 2 and wave plate 5, is collected at objective lens 6, and enters optical disk 7. Reflected light from optical disk 7 passes through objective lens 6, wave plate 5 and polarization hologram element 2 to be diffracted at non-polarization hologram element 3.

Wave plate 5 is formed to act as a λ/2 plate or λ plate for the second laser beam. When wave plate 5 acts as a λ/2 plate for the second laser beam, the emitted second laser beam passes through wave plate 5 to attain the linear polarization state with 180° rotation with respect to the polarization direction of the laser light emitted from light source 1b. In this state, it enters optical disk 7. Reflected light from optical disk 7 enters wave plate 5 again. The reflected light from the optical disk passes through wave plate 5 again to attain the linear polarization state having the same polarization direction as the laser light emitted from light source 1b. Therefore, reflected light of the second laser beam is transmitted through polarization hologram element 2 without being diffracted. On the other hand, since laser light is diffracted at non-polarization hologram element 3 irrespective of the polarization state, the reflected light of the second laser beam is diffracted at non-polarization hologram element 3 and is then introduced to light-receiving portion 4b.

When wave plate 5 acts as a λ plate for the second laser beam, the second laser beam emitted from light source 1b enters optical disk 7 in the same polarization state as the polarization direction of the emitted laser light when passing through wave plate 5. Reflected light from optical disk 7 passes through wave plate 5 again thereby attaining the same linear polarization state as the oscillation light. Therefore, the second laser beam is not diffracted at polarization hologram element 2 and is diffracted at non-polarization hologram element 3 to be received at light-receiving portion 4b.

In this way, the wave plate as a phase difference plate is formed to act as a λ/4 plate for the first laser beam and additionally act as a λ plate or λ/2 plate for the second laser beam, so that the utilization efficiency of laser light can be increased. In addition, it is possible to provide an optical integrated unit and an optical pickup device that allows for miniaturization.

Polarization hologram element 2 as a first hologram element is formed to have a polarization characteristic and non-polarization hologram element 3 as a second hologram element is formed not to have a polarization characteristic. By employing this configuration, the loss of quantity of light can be reduced when the second laser beam passes through the first hologram element, so that the utilization efficiency of the second laser beam can be increased. In addition, the first hologram element and the second hologram element can be formed easily.

In the present embodiment, a polarization hologram element is used as a first hologram element for diffracting the first laser beam having a short wavelength, and a non-polarization hologram element is used as a second hologram element for diffracting the second laser beam having a long wavelength. However, the present invention is not limited to this manner, and a non-polarization hologram element may be used as a first hologram element and a polarization hologram element may be used as a second hologram element.

Here, a phase difference plate will be described in detail which has the action of λ/4 plate for one laser beam and has the action of λ/2 plate or λ plate for the other laser beam.

In the phase difference plate, if refractive indexes in the two directions orthogonal to each other are Np, Ns, respectively, and the thickness of the phase difference plate is d, the produced phase difference Δ is as follows.

Δ=(Np−Ns)×d (1)

For example, if the wavelength of the first laser beam is 655 nm, phase difference Δ is given by the following equation where the phase difference plate acts as a λ/4 plate.

Δ=(Np−Ns)×d=0.655×(2k−1)/4 (2)

where k is any positive integer.

On the other hand, if the wavelength of the second laser beam is 785 nm, phase difference Δ is given by the following equation where the phase difference plate acts as a λ/2 plate (or λ plate).

Δ=(Np−Ns)×d=0.785×j/2 (3)

where j is any positive integer.

In order to satisfy these conditions at the same time, the following condition needs to be satisfied based on the equation (2) and the equation (3).

0.655×(2k−1)/4=0.785×j/2 (4)

By defining k and j such that the equation (4) is satisfied, a phase difference plate having the above-noted characteristic can be formed.

For example, in the second laser beam, when j=3, phase difference Δ is:

Δ=0.785×3/2=1.1775.

If this phase difference Δ is applied to the equation (2) for the first laser beam,

Δ/0.655=1.798≈1.75=(2k−1)/4(k=4)

Therefore, the action of almost λ/4 plate is achieved for the first laser beam.

In this way, by optimizing k and j, such a phase difference plate can be formed that has the characteristic of converting linear polarization into circularly polarized light (the action of λ/4 plate) for one laser beam and keeping linear polarization (the action of λ/2 plate or λ plate) for the other laser beam.

Non-polarization hologram element 3 as a second hologram element is formed not to diffract the first laser beam and to diffract the second laser beam. In other words, non-polarization hologram element 3 has wavelength selectivity. By employing this configuration, the loss of quantity of light can be reduced when the first laser beam emitted from light source 1a passes through non-polarization hologram element 3, so that the utilization efficiency of the first laser beam can be increased.

For example, when the first laser beam is used to record information onto optical disk 7, the quantity of light of the first laser beam applied from objective lens 6 can be increased, thereby allowing for high-speed recording or high-speed reproduction onto/from optical disk 7.

In addition, the second hologram element has wavelength selectivity, so that even if the diffraction light of the first laser beam in the first hologram element passes through the region in which the second hologram element is formed, the first laser beam is transmitted without being diffracted at the second hologram element, thereby preventing the loss of quantity of light. Therefore, while the loss of quantity of light is prevented, the first hologram element and the second hologram element can be brought closer to each other, thereby achieving miniaturization of the optical integrated unit and the optical pickup device.

In non-polarization hologram element 3, preferably, the efficiency of transmitted light (zero-order diffraction light) is high and the efficiency of ±1 order diffraction light is low. For example, as in the present embodiment, non-polarization hologram element 3 is formed to have the efficiency of zero-order diffraction of about 80% and the efficiency of ±1 order diffraction of 8%. By employing this configuration, even if the non-polarization hologram element does not have wavelength selectivity, it is possible to minimize the loss of quantity of light when the first laser beam emitted from light source 1a passes through non-polarization hologram element 3.

In addition, the loss of quantity of light can be reduced when laser light emitted from light source 1b is directed to optical disk 7. For example, when the second laser beam emitted from light source 1b is laser light for recording in CD, the quantity of laser light applied to an optical disk (CD) can be increased, thereby accommodating high-speed recording. On the other hand, since the recording density of CD is lower than that of DVD and the like, reflected light from an optical disk (CD) does not have to be significantly increased in quantity, and good reproduction and recording can be performed sufficiently with the above-noted diffraction efficiency.

In the second optical integrated unit and the optical pickup device shown in FIG. 2, two light-receiving portions 4a, 4b are arranged on the same side of light-emitting portion 1. By employing this configuration, the light-receiving portions can be put together at one location, thereby achieving further miniaturization of the optical integrated unit and the optical pickup device. In the second optical integrated unit and the second optical pickup device, the main surface of light-receiving portion 4a and the main surface of light-receiving portion 4b are arranged to be approximately in the same plane. However, the present invention is not limited to this manner, and, for example, light-receiving portion 4a may be arranged above light-receiving portion 4b in the direction of the optical axis of laser beam, in FIG. 2.

The third optical integrated unit and the third optical pickup device shown in FIG. 3 are formed such that the emitted two laser beams are received at one light-receiving portion 4c. By employing this configuration, miniaturization of the light-receiving portion can be achieved, thereby achieving further miniaturization of the optical integrated unit and the optical pickup device. In this manner, the optical integrated unit and the optical pickup device in accordance with the present invention has a higher degree of flexibility in arrangement of the light-receiving portion.

In the present embodiment, light-source 1a and light-source 1b included in light-emitting portion 1 are arranged to be aligned to each other. The respective light-emitting points of light sources 1a, 1b are spaced apart from each other by about 110 μm. Therefore, optical axis J of the first laser beam and the optical axis of the second laser beam are arranged at slightly different positions. Also in this case, the first hologram element for diffracting the first laser beam and the second hologram element for diffracting the second laser beam are included, so that hologram elements can be arranged individually for the respective laser beams. Therefore, each laser beam can be introduced to the light-receiving portion in the optimum state.

In the present embodiment, laser light emitted from light-emitting portion 1 includes two kinds of laser beams. However, the present invention is not limited to this manner and is applicable to an optical integrated unit and an optical pickup device including a light-emitting portion emitting three or more kinds of laser beams. In this case, the laser beams are diffracted individually so that their respective hologram elements are preferably included.

### Second Embodiment

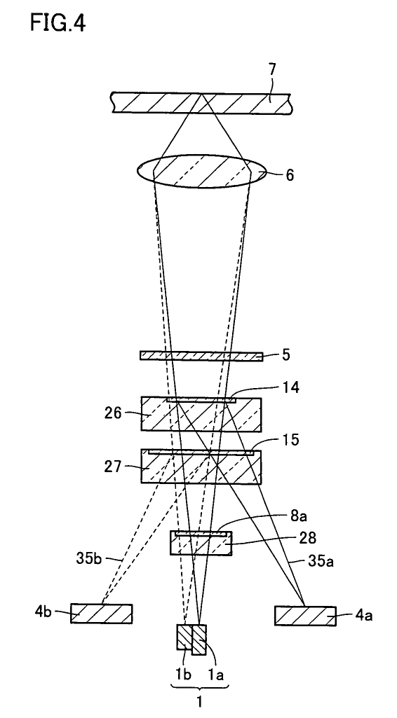

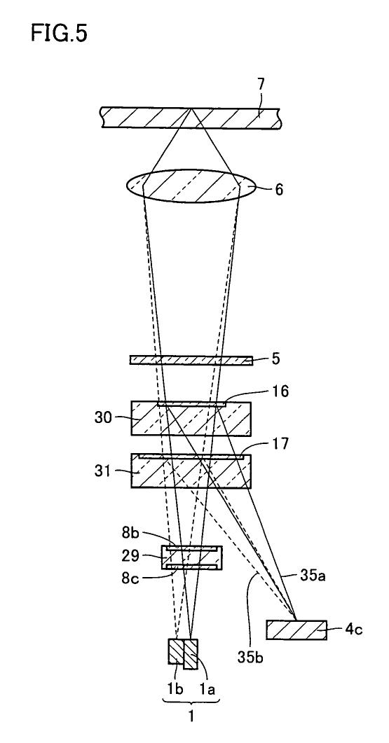

Referring to FIG. 4 and FIG. 5, an optical integrated unit and an optical pickup device in accordance with a second embodiment of the present invention will be described.

The optical integrated unit and the optical pickup device in the present embodiment includes a polarization hologram element, a non-polarization hologram element and a phase difference plate, similarly to the optical integrated unit and the optical pickup device in the first embodiment. In addition, the light-emitting portion includes two light sources formed to emit two laser beams, similarly to the optical integrated unit and the optical pickup device in the first embodiment. In the present embodiment, an oscillation light division means is included to divide oscillation light.

FIG. 4 is a schematic cross sectional view of a first optical integrated unit and optical pickup device in the present embodiment. A polarization hologram element 14 is formed on the upper surface of a substrate 26 and a non-polarization hologram element 15 is formed on the upper surface of a substrate 27.

A diffraction grating 8a is formed between light-emitting portion 1 and substrate 27 as oscillation light division means for dividing oscillation light from light-emitting portion 1 into at least three. Diffraction grating 8a is formed to divide each of the first laser beam emitted from light source 1a and the second laser beam emitted from light source 1b. Diffraction grating 8a is formed on the upper surface of a substrate 28. Diffraction grating 8a is formed such that two laser beams emitted from light-emitting portion 1 pass through within the region in which diffraction grating 8a is formed.

Light-receiving portion 4a and light-receiving portion 4b are formed on the side of light-emitting portion 1. Light-emitting portion 4b is arranged on the side opposite to the side at which light-receiving portion 4a is arranged, with respect to light-emitting portion 1. Polarization hologram element 14 and non-polarization hologram element 15 are formed to pass diffraction light for use in optical detection, of the diffraction light of oscillation light which is diffracted at diffraction grating 8a.

FIG. 5 shows a schematic cross sectional view of a second optical integrated unit and a second optical pickup device in the present embodiment. A polarization hologram element 16 is formed on a substrate 30 and a non-polarization hologram element 17 is formed on a substrate 31, similarly to the first optical integrated unit and the first optical pickup device in the present embodiment.

In the second optical integrated unit and the second optical pickup device, a diffraction grating 8b and a diffraction grating 8c are formed on the upper and lower main surfaces of a substrate 29. Diffraction grating 8b is formed as a first oscillation light diffraction grating for dividing the first laser beam emitted from light source 1a. Diffraction grating 8c is formed as a second oscillation light diffraction grating for dividing the second laser beam. In this way, in the second optical integrated unit and optical pickup device, the oscillation light division means includes two diffraction gratings. Diffraction grating 8b is formed in the region through which the first laser beam passes and diffraction grating 8c is formed in the region through which the second laser beam passes.

Furthermore, diffraction grating 8b is formed not to diffract the second laser beam and to diffract the first laser beam, and diffraction grating 8c is formed not to diffract the first laser beam and to diffract the second laser beam. In other words, the oscillation light division means in this embodiment has wavelength selectivity.

Polarization hologram element 16 is formed in the region through which the first laser beam passes, and non-polarization hologram element 17 is formed in the region through which the second laser beam passes. Furthermore, in the second optical integrated unit and the second optical pickup device, light-receiving portion 4c is arranged on the side of light-emitting portion 1 and this one light-receiving portion is formed to receive two laser beams emitted from light-emitting portion 1.

Except for the foregoing description, the configuration is similar to that of the optical integrated unit and the optical pickup device in the first embodiment, and therefore the description thereof will not be repeated here.

The first optical integrated unit and the first optical pickup device in the present embodiment shown in FIG. 4 include oscillation light division means for dividing oscillation light from the light-emitting portion into at least three. By employing this configuration, the present invention is applicable to a tracking-type optical integrated unit and optical pickup device using three beams.

In addition, in the first optical integrated unit and the first optical pickup device, diffraction grating 8a as oscillation light division means is formed to divide the first laser beam and the second laser beam. In other words, one diffraction grating 8a divides two laser beams. By employing this configuration, the configuration of the oscillation light division means can be made simple.

Each of the first laser beam emitted from light source 1a and the second laser beam emitted from light source 1b is divided into a main beam and a sub-beam at diffraction grating 8a. The main beam and the sub-beam are provided with the action similar to the laser light in the first embodiment at polarization hologram element 14 and non-polarization hologram element 15. The main beam and sub-beam of the first laser beam emitted from light source 1a are received at light-receiving portion 4a while the main beam and sub-beam of the second laser beam emitted from light source 1b are received at light-receiving portion 4b.

In the second optical integrated unit and the second optical pickup device in FIG. 5, diffraction gratings 8b, 8c are formed on substrate 29 corresponding to the emitted, two laser beams, respectively. By employing this configuration, for each of a plurality of emitted laser beams, the oscillation light can be divided at the optimum diffraction angle and diffraction efficiency. In addition, diffraction grating 8b is formed not to diffract the second laser beam and to diffract the first laser beam while diffraction grating 8c is formed not to diffract the first laser beam and to diffract the second laser beam. By employing this configuration, the loss of quantity of oscillation light can be reduced, so that the utilization efficiency of laser light can be improved.

In the second optical integrated unit and the second optical pickup device, two laser beams are received at one light-receiving portion 4c. Since the laser beams emitted from light sources 1a, 1b have their respective different wavelengths, the diffraction angle is different between the two laser beams when they pass through the same oscillation light division means. Therefore, the laser beams fall upon the light-receiving portion at significantly different places, which makes it difficult to receive two laser beams at one light-receiving portion. However, as in the second optical integrated unit and the second optical pickup device shown in FIG. 5, diffraction gratings 8b, 8c are formed for the respective laser beams, so that approximately the same diffraction angle can easily be achieved for a plurality of laser beams. Therefore, a plurality of laser beams can easily be received at one light-receiving portion. In other words, even when a plurality of laser beams are used, the positions of a plurality of laser beams falling upon light-receiving portion 4c can easily be controlled individually.

Except for the foregoing description, the operation and effect is similar to that of the optical integrated unit and the optical pickup device in the first embodiment, and therefore the description will not be repeated here.

### Third Embodiment

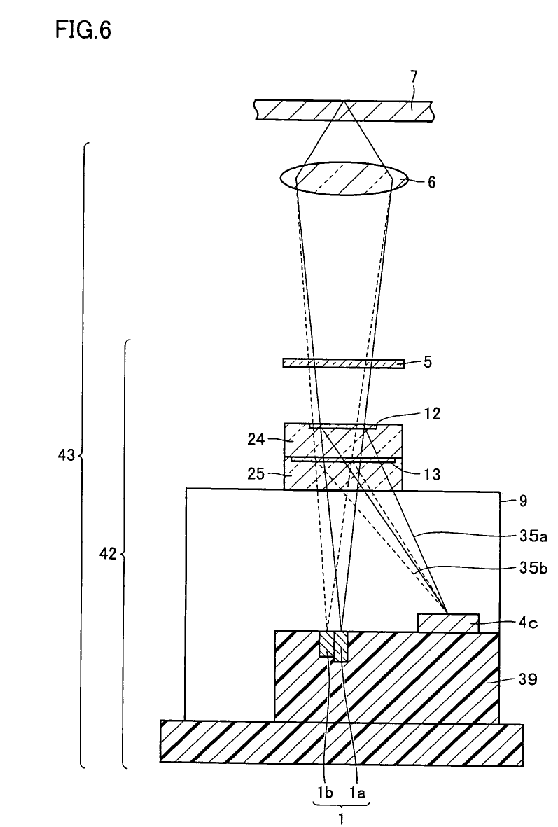

Referring to FIG. 6 to FIG. 10, an optical integrated unit and an optical pickup device in accordance with a third embodiment of the present invention will be described. In the present embodiment, with reference to the optical integrated unit and the optical pickup device described in the first embodiment and the second embodiment, a specific form of equipment will be described.

FIG. 6 is a schematic cross sectional view of a first optical integrated unit and a first optical pickup device in the present embodiment. The first optical integrated unit and the first optical pickup device are formed by attaching the third optical integrated unit and the third optical pickup device (see FIG. 3) in the first embodiment to a fixing member.

In a first optical integrated unit 42, light-emitting portion 1, light-receiving portion 4c, polarization hologram element 12, and non-polarization hologram element 13 are integrated using a holder 9. A base 39 for fixing light-emitting portion 1 and light-receiving portion 4c is formed at the lower part inside holder 9. Light-emitting portion 1 includes light sources 1a, 1b and is fixed on the upper surface of base 39. In addition, light-receiving portion 4c is also fixed on the upper surface of base 39. Inside holder 9, the upper part above base 39 is hollow.

Substrate 25 and substrate 24 are adhesively fixed on the upper surface of holder 9. Substrate 25 and substrate 24 are arranged in a stacked manner. The upper surface of holder 9 is formed to be flat, and the main surface of plate-like substrate 25 is adhesively fixed on the upper surface of holder 9. Non-polarization hologram element 13 is formed on the upper surface of substrate 25. Polarization hologram element 12 is formed on the upper surface of substrate 24.

Substrate 24 and substrate 25 are arranged such that the main surface of polarization hologram element 12 and the main surface of non-polarization hologram element 13 are approximately vertical to the optical axes of the respective laser beams emitted from light-emitting portion 1. Wave plate 5 is arranged spaced apart from substrate 24.

In optical pickup device 43, objective lens 6 is arranged spaced apart from wave plate 5. Objective lens 6 is arranged on the optical axis of each laser beam emitted from light-emitting portion 1 and is fixed by not-shown fixing means.

As described above, in the first optical integrated unit and the first optical pickup device, light-emitting portion 1, light-receiving portion 4c, polarization hologram element 12 as a first hologram element, and non-polarization hologram element 13 as a second hologram element are integrated. The other configuration is similar to that of the third optical integrated unit and the third optical pickup device in the first embodiment.

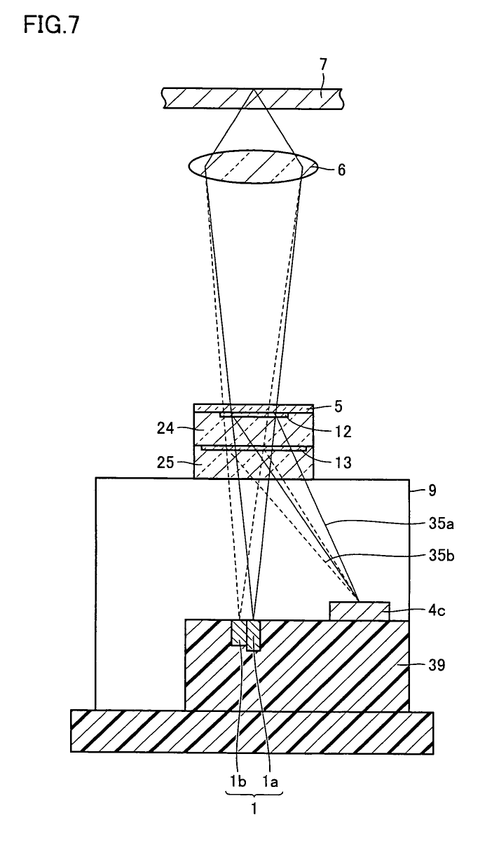

FIG. 7 shows a schematic cross sectional view of the second optical integrated unit and the second optical pickup device in the present embodiment. The second optical integrated unit and the second optical pickup device include holder 9, light-emitting portion 1 and light-receiving portion 4c fixed inside holder 9, and substrate 25 and substrate 24 fixed on the upper surface of holder 9, similarly to the first optical integrated unit and the first optical pickup device in the present embodiment.

In the second optical integrated unit and the second optical pickup device, wave plate 5 serving as a phase difference plate is adhesively fixed on the upper surface of substrate 24. Wave plate 5 is bonded and fixed such that its main surface is opposed to the main surface of substrate 24. In this way, in the second optical integrated unit and the second optical pickup device, light-emitting portion 1, light-receiving portion 4c, polarization hologram element 12, non-polarization hologram element 13, and wave plate 5 as a phase difference plate are integrated. The other configuration is similar to that of the first optical integrated unit and the optical pickup device in the present embodiment.

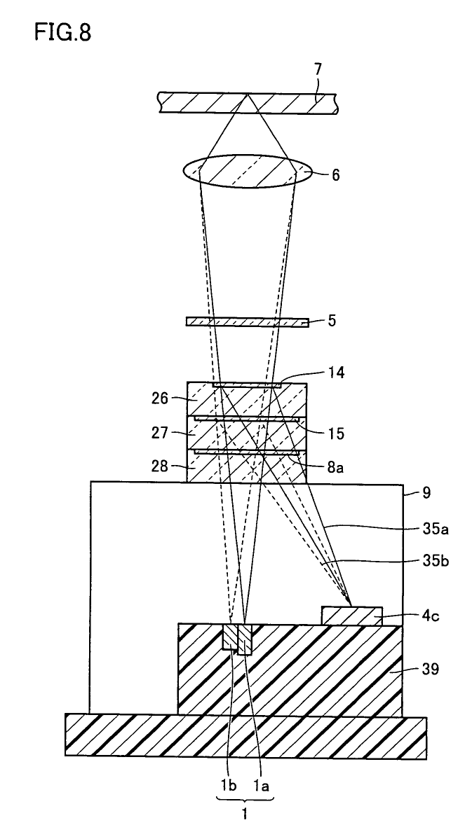

FIG. 8 shows a schematic cross sectional view of a third optical integrated unit and a third optical pickup device in the present embodiment. The third optical integrated unit and the third optical pickup device are same as the first optical integrated unit and the first optical pickup device (see FIG. 4) in the second embodiment attached to a fixing member, except that two laser beams are received at one light-receiving portion.

Light-emitting portion 1 and light-receiving portion 4c are fixed to base 39 formed inside holder 9. The third optical integrated unit and the third optical pickup device include diffraction grating 8a as oscillation light division means. Diffraction grating 8a is formed on the upper surface of substrate 28. Substrate 28 is fixed on the upper surface of holder 9, and substrate 27 having non-polarization hologram element 15 formed thereon is fixed on the upper surface of substrate 28. A substrate 26 having polarization hologram element 14 formed thereon is fixed on the upper surface of substrate 27. Substrate 28, substrate 27, and substrate 26 are adhesively fixed on the upper surface of holder 9 in a stacked manner.

Wave plate 5 is arranged apart from substrate 26. Polarization hologram element 14, non-polarization hologram element 15 and diffraction grating 8a have their respective main surfaces to be approximately vertical to the optical axis of the laser light emitted from light-emitting portion 1.

In this way, in the third optical integrated unit and the third optical pickup device, light-emitting portion 1, light-receiving portion 4c, polarization hologram element 14, non-polarization hologram element 15, and diffraction grating 8a are integrated.

Light-receiving portion 4c is formed to receive both of diffraction light from polarization hologram element 14 and diffraction light from non-polarization hologram element 15. Furthermore, polarization hologram element 14 and non-polarization hologram element 15 are formed such that first-order diffraction light reaches light-receiving portion 4c. The other configuration is similar to that of the first optical integrated unit and the first optical pickup device in the second embodiment.

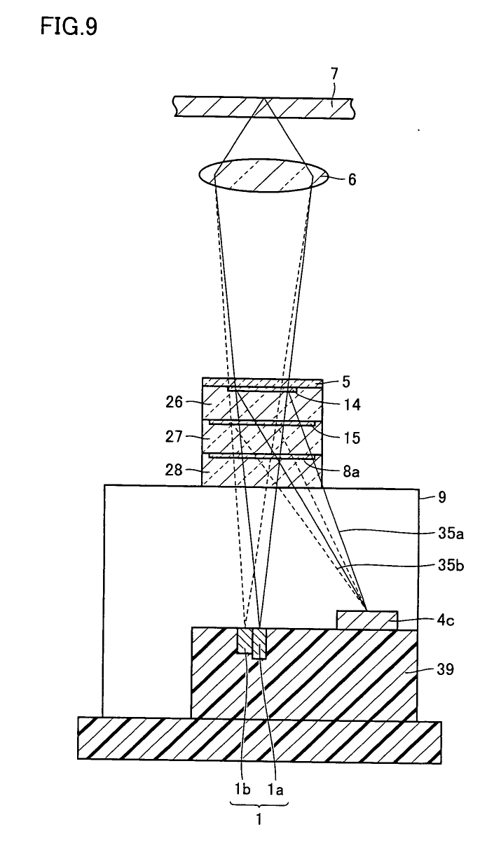

FIG. 9 shows a schematic cross sectional view of a fourth optical integrated unit and a fourth optical pickup device in this embodiment. The fourth optical integrated unit and the fourth optical pickup device include holder 9 and have light-emitting portion 1 and light-receiving portion 4c fixed inside holder 9, similarly to the third optical integrated unit and the third optical pickup device in the present embodiment.

In the fourth optical integrated unit and the fourth optical pickup device, wave plate 5 is adhesively fixed on the upper surface of substrate 26. In other words, wave plate 5, substrate 26, substrate 27, and substrate 28 are adhesively fixed on the upper surface of holder 9 in a stacked manner. In this way, in the fourth optical integrated unit and the fourth optical pickup device, light-emitting portion 1, light-receiving portion 4c, polarization hologram element 14, non-polarization hologram element 15, wave plate 5, and diffraction grating 8a are integrally formed. The other configuration is similar to that of the third optical integrated unit and the third optical pickup device in the present embodiment.

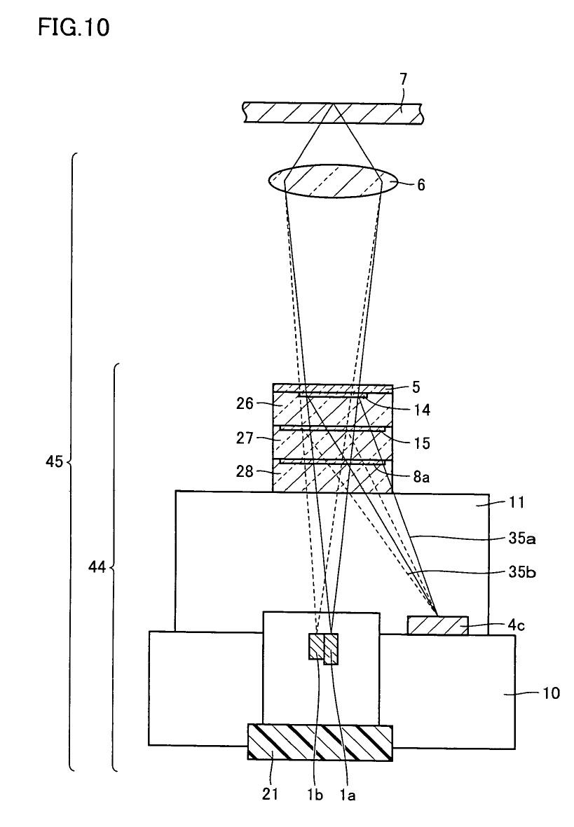

FIG. 10 shows a schematic cross sectional view of a fifth optical integrated unit and a fifth optical pickup device in the present embodiment. In the fifth optical integrated unit and the fifth optical pickup device, a light-emitting portion 21 is integrally formed such that it can be separated from the other part in the configuration of the fourth optical integrated unit and the fourth optical pickup device.

A fifth optical integrated unit 44 includes a holder 10 and a holder 11. Holder 11 is formed in a box-shaped having the hollow inside. Light-receiving portion 4c is fixed on the upper surface of holder 10. Holder 11 is arranged on the upper surface of holder 10. Light-receiving portion 4c is arranged inside holder 11. Light-emitting portion 21 is fixed approximately at the middle portion of holder 10. Light-emitting portion 21 is packaged alone and includes light sources 1a, 1b inside thereof Light-emitting portion 21 is formed to be removable from holder 10. Substrate 28, substrate 27, substrate 26, and wave plate 5 are adhesively fixed in a stacked manner on the upper surface of holder 11.

A fifth optical pickup device 45 includes fifth optical integrated unit 44 and objective lens 6. The other configuration is similar to that of the fourth optical integrated unit and the fourth optical pickup device in the present embodiment.

In the optical integrated unit and the optical pickup device in the present embodiment, except for the foregoing description, the configuration is similar to that of the optical integrated unit and the optical pickup device in the first embodiment or the second embodiment, and therefore the description will not be repeated here.

The optical integrated unit in the present embodiment includes a plurality of parts combined into a module, so that the positions of a plurality of parts can be adjusted to each other in manufacturing the optical integrated unit.

In the first optical integrated unit and the first optical pickup device in the present embodiment shown in FIG. 6, light-emitting portion 1, light-receiving portion 4c, polarization hologram element 12, and non-polarization hologram element 13 are integrated. In other words, these plurality of parts are combined into a module.

For the position adjustment inside the module in the optical integrated unit shown in FIG. 6, light sources 1a, 1b are initially positioned inside holder 9 so that light sources 1a, 1b are adhesively fixed. In addition, light-receiving portion 4c is positioned inside holder 9 so that light-receiving portion 4c is adhesively fixed. Then, after the position of substrate 25 having non-polarization hologram element 13 formed thereon is adjusted to the optical axis of laser light emitted from light-emitting portion 1, substrate 25 is adhesively fixed to holder 9. Thereafter, the position of substrate 24 having polarization hologram element 12 formed thereon is adjusted so that substrate 24 is adhesively fixed on the upper surface of substrate 25.

Light-emitting portion 1, light-receiving portion 4c, polarization hologram element 12, and non-polarization hologram element 13 are integrated, so that the position of light-emitting portion 1, light-receiving portion 4c, polarization hologram element 12, and non-polarization hologram element 13 can be adjusted for each integrated module. Thus, when optical integrated unit 42 is installed in optical pickup device 43, the positions of the above-noted parts included in the optical integrated unit need not be adjusted to each other.

In the second optical integrated unit and the second optical pickup device in the present embodiment shown in FIG. 7, light-emitting portion 1, light-receiving portion 4c, polarization hologram element 12, non-polarization hologram element 13, and wave plate 5 are integrated.

In the second optical integrated unit, after light-emitting portion 1 and light-receiving portion 4c are adhesively fixed inside holder 9, substrate 25 and substrate 24 are adhesively fixed on the upper surface of holder 9 in a stacked manner. Thereafter, wave plate 5 is adhesively fixed on the upper surface of substrate 24 in a stacked manner. In this way, also in the second optical integrated unit, the position of each part can be adjusted beforehand in the integrated module. Thus, when the optical integrated unit is installed in the optical pickup device, the position of each part inside the module needs not be adjusted.

In addition, in the second optical integrated unit, since wave plate 5 is adhesively fixed on the upper surface of substrate 24, the distance between wave plate 5 and light-emitting portion 1 is reduced. Therefore, the area where laser light emitted from light-emitting portion 1 is transmitted through wave plate 5 is reduced, so that aberration of the transmitted wavefront resulting from a fabrication error of wave plate 5 and the like can be reduced. Therefore, laser light applied to optical disk 7 can be excellent with small aberration.

In the third optical integrated unit and the third optical pickup device shown in FIG. 8, light-emitting portion 1, light-receiving portion 4c, polarization hologram element 14, non-polarization hologram element 15, and diffraction grating 8a are integrated.

In the third optical integrated unit, light-emitting portion 1 and light-receiving portion 4c are positioned inside holder 9 so that light-emitting portion 1 and light-receiving portion 4c are adhesively fixed to holder 9. On the other hand, substrate 28 having diffraction grating 8a formed thereon and substrate 27 having non-polarization hologram element 15 formed thereon are adhesively fixed to each other for integration. This member is adhesively fixed on the upper surface of holder 9 with its position being adjusted. Thereafter, while the position of substrate 26 having polarization hologram element 14 formed thereon is being adjusted, substrate 26 is adhesively fixed on the upper surface of substrate 27. In this way, also in the third optical integrated unit, the position of polarization hologram element 14, non-polarization hologram element 15, diffraction grating 8a, and the like can be adjusted beforehand, thereby eliminating the necessity for the position adjustment when the optical integrated unit is installed in the optical pickup device.

In the third optical integrated unit, non-polarization hologram element 15 and diffraction grating 8a are formed on the substrates different from each other. However, they need not be formed separately, and for example, diffraction grating 8a may be formed beforehand on that main surface of substrate 27 which is on the side opposite to the side at which non-polarization hologram element 15 is formed.

In the fourth optical integrated unit and the fourth optical pickup device shown in FIG. 9, light-emitting portion 1, light-receiving portion 4c, polarization hologram element 14, non-polarization hologram element 15, and diffraction grating 8a as well as wave plate 5 are integrated. In the fourth optical integrated unit, substrates 26, 27, 28 are fixed in a stacked manner on the upper surface of holder 9 having light-emitting portion 1 and light-receiving portion 4c arranged therein, and thereafter wave plate 5 is adhesively fixed.

Also in the fourth optical integrated unit, the above-noted parts can be integrated and combined into a module, thereby eliminating the necessity for position adjustment when the optical integrated unit is installed in the optical pickup device. Moreover, similarly to the second optical integrated unit in the present embodiment, wave plate 5 can be arranged close to light-emitting portion 1, thereby reducing aberration of the transmission wavefront resulting from the precision of wave plate 5 and the like. The other operation and effect is similar to that of the third embodiment.

In the fifth optical integrated unit and the fifth optical pickup device shown in FIG. 10, light-emitting portion 21 is integrally formed such that it can be separated from the other part.

In the fifth optical integrated unit, first, light-emitting portion 21 and light-receiving portion 4c are adhesively fixed to holder 10 with their positions being adjusted. Then, while the positions of diffraction grating 8a, non-polarization hologram element 15, polarization hologram element 14, and wave plate 5 are adjusted with holder 11 interposed, substrates 26-28 and wave plate 5 are adhesively fixed on the upper surface of holder 11 in a stacked manner.

Light-emitting portion 21 is integrally formed such that it can be separated from the other part, so that light-emitting portion 21 alone can easily be replaced with a different one. Since the casing of light-emitting portion 21 often has a common shape and a common size among manufacturers, light-emitting portion 21 can be changed to one from a different manufacture as appropriate in manufacturing the optical integrated unit. In other words, the degree of flexibility in manufacturing can be increased. In addition, light-emitting portion 21 can easily be replaced in the event of a failure.

Except for the foregoing description, the operation and effect is similar to that of the first embodiment and the second embodiment, and therefore the description will not be repeated here.

In the present embodiment, the description has been made to the example with one light-receiving portion where the optical integrated unit in the first embodiment and the second embodiment is modulized. However, the present invention is not limited to this manner, and a plurality of light-receiving portions may be formed.

In all of the embodiments above, the hologram for diffracting laser light, such as the polarization hologram element and the non-polarization hologram element, may be divided to have different gratings in a plurality of regions.

It is noted that the foregoing embodiments disclosed herein are not limitative but illustrative in all the aspects. The scope of the invention is shown not in the foregoing description but in the claims, and all the equivalences to the claims and modifications within the claims are embraced herein.

### INDUSTRIAL APPLICABILITY

The present invention is applicable to an optical integrated unit and an optical pickup device for optically recording or reproducing information onto/from an information recording medium such as an optical disk.

1. An optical integrated unit comprising:
a light-emitting portion for emitting a plurality of laser beams having different wavelengths;
a phase difference plate;
a first hologram element for diffracting a first laser beam of said plurality of laser beams; and
a second hologram element for diffracting a second laser beam of said plurality of laser beams, wherein
said phase difference plate is formed to act as a λ/4 plate for said first laser beam and to act as a λ plate or a λ/2 plate for said second laser beam.

2. The optical integrated unit according to claim 1, wherein said light-emitting portion is formed such that a wavelength of said first laser beam is shorter than a wavelength of said second laser beam,
said first hologram element has a polarization characteristic, and
said second hologram element is formed not to depend on a polarization state.

3. The optical integrated unit according to claim 1, wherein
said light-emitting portion is formed such that a wavelength of said first laser beam is shorter than a wavelength of said second laser beam,
said first hologram element has a polarization characteristic, and
said second hologram element is formed not to diffract said first laser beam and to diffract said second laser beam.

4. The optical integrated unit according to claim 1, further comprising oscillation light division means for dividing oscillation light from said light-emitting portion into at least three.

5. The optical integrated unit according to claim 4, wherein said oscillation light division means includes
a first oscillation light diffraction grating for dividing said first laser beam and
a second oscillation light diffraction grating for dividing said second laser beam.

6. The optical integrated unit according to claim 4, wherein said oscillation light division means includes a diffraction grating formed to divide said first laser beam and said second laser beam.

7. The optical integrated unit according to claim 1, further comprising one light-receiving portion for receiving said plurality of laser beams, wherein
said first laser beam and said second laser beam are received at said one light-receiving portion.

8. The optical integrated unit according to claim 1, further comprising a light-receiving portion for receiving said plurality of laser beams, wherein
said light-emitting portion, said light-receiving portion, said first hologram element, and said second hologram element are integrated.

9. The optical integrated unit according to claim 1, further comprising a light-receiving portion for receiving said plurality of laser beams, wherein
said light-emitting portion, said light-receiving portion, said first hologram element, and said second hologram element, and said phase difference plate are integrated.

10. The optical integrated unit according to claim 1, further comprising:
oscillation light division means for dividing oscillation light from said light-emitting portion into at least three; and
a light-receiving portion for receiving said plurality of laser beams, wherein
said light-emitting portion, said light-receiving portion, said first hologram element, said second hologram element, and said oscillation light division means are integrated.

11. The optical integrated unit according to claim 1, further comprising:
oscillation light division means for dividing oscillation light from said light-emitting portion into at least three; and
a light-receiving portion for receiving said plurality of laser beams, wherein
said light-emitting portion, said light-receiving portion, said first hologram element, said second hologram element, said phase difference plate, and said oscillation light division means are integrated.

12. The optical integrated unit according to claim 1, wherein said light-emitting portion is integrally formed to be separable from other portions.

13. An optical pickup device comprising:
the optical integrated unit according to claim 1; and
an objective lens for collecting emitted laser beam on an information surface of an optical disk.

14. The optical pickup device according to claim 13, further comprising:
oscillation light division means for dividing oscillation light from said light-emitting portion into at least three; and
a light-receiving portion for receiving said plurality of laser beams, wherein
said light-emitting portion is formed such that a wavelength of said first laser beam is shorter than a wavelength of said second laser beam,
said first hologram element has a polarization characteristic,
said second hologram element is formed not to depend on a polarization state, and
said light-emitting portion, said light-receiving portion, said first hologram element, said second hologram element, said phase difference plate, and said oscillation light division means are integrated.
